(19) United States
(12) Patent Application Publication
(10) Pub. No.: US 2011/0302091 A1
(43) Pub. Date: Dec. 8, 2011

(54) Auto Repair Estimation System

(76) Inventor: Robert Hornedo, Long Beach, CA (US)

(21) Appl. No.: 12/795,319

(22) Filed: Jun. 7, 2010

(51) Int. Cl. G06Q 10/00; G06Q 50/00; G01B 21/02; G01M 17/00

(52) U.S. Cl. 705/305; 701/33; 705/348; 702/158

(57) ABSTRACT

A system for estimating cost or time to repair a damaged vehicle includes an electronic measuring system that can measure control points of the vehicle and determine whether those control points are out of tolerance (i.e., damaged) even though the damage is not perceptible by the human eye. The system further takes into account various efficiencies and inefficiencies due to extent of damage, type of material, etc. by adding to or subtracting from estimated cost or time.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates to a system for estimating a time or cost (time×$/hr) to repair a damaged vehicle.

Prior art systems for estimating the cost to repair a damaged vehicle exist. These systems estimate the time to repair the damaged vehicle by visually inspecting the extent of the damage to the vehicle. These prior art systems rely upon the judgment of the estimator to visually inspect the damage to the vehicle correctly. For example, one such system relies upon a three tiered approach. The system requires that the estimator inspects a damaged structural component and assign one of three codes. For moderate damage, a middle code is assigned. For minor damage, the lowest code is assigned. For heavy damage, the highest code is assigned. These codes are associated with time. This system is very crude with three different damage ratings. This system also requires that the judgment of the estimator be accurate. Additionally, this system requires the estimator to be correct as to the extent of the damage to the vehicle. Moreover, the extent of the damage may be judged differently by different estimators. Accordingly, there is a wide variant in the end result number for the estimated time or cost to repair the damaged vehicle between estimators and repair shops.

Accordingly, there is a need in the art for an improved system for estimating the cost or time to repair the damaged vehicle.

### BRIEF SUMMARY

The auto repair estimation system disclosed herein addresses the needs discussed above, discussed below and those that are known in the art.

The system measures locations of control points within a damaged area of a vehicle so that even damage that is not noticeable by the naked eye is measured and an associated time to repair is assigned to such damage. Generally, as the amount of displacement of the control point increases, the estimated time to repair also increases. Deductions and additions may be made to the estimated time to repair based on efficiency of certain combinations of damages and other factors. By way of example and not limitation, if one control point is out of tolerance in all three directions length, width and height, then a deduction (e.g., set time or percentage time) may be made to the cumulated estimated time to repair. The cumulated estimated time to repair is the sum of the estimated times to repair to bring a control point back into tolerance in the lengthwise L direction, width W direction and the height H direction. Additions may be made to the cumulated estimated time to repair when the structural component is fabricated from a variety of different advanced high strength steel. Moreover, when there are two control points on one structural component, the system may measure the displacement of both control points and the extent to which these control points are out of tolerance. Based on the extent to which these control points are out of tolerance, the system may assign an estimated time to repair to each of the control points independently. The system may assign the higher of the two estimated time to repair to the damaged structural component to bring such component back to a vehicle manufacturer or industry accepted dimensional condition. The lower of the two estimated time to repair may be ignored.

More particularly, a method for estimating time to repair a structurally damaged automobile is disclosed. The method may comprise the steps of identifying a damaged structural component of the structurally damaged automobile; electronically measuring length, width and height dimensions of a control point on the damaged structural component; based on a difference between the measured length, width and height and a standard length, width and height of the control point on the damaged structural component, assigning an estimated time to repair for each of the measured length, width and height; and cumulating the assigned times for the length, width and height to derive a cumulated estimated time to repair the control point; wherein the cumulated time is the estimated time to repair the damaged structural component.

The damaged structural component may have one, two or more control points. When the damaged structural component has two or more control points, at least two of the control points may be measured and a cumulated time to repair each of the control points derived. The higher of the two cumulated times to repair may be used as the estimated time to repair the damaged structural component.

The method may further comprise the steps of identifying additional damaged structural components of the structurally damaged automobile; for each of the identified damaged structural components, measuring length, width and height dimensions of one or more control points on the damaged structural component; for each of the control points, assigning an estimated time to repair each of the measured length, width and height; and cumulating the assigned times for the length, width and height of each control point.

The method may also further comprise the steps of assigning a first estimated time to repair the length, width and height of the control point for a first difference; and assigning a second estimated time to repair the length, width and height of the control point for a second difference wherein the second estimated time to repair is greater than the first estimated time to repair when the second difference is greater than the first difference.

The method may also further comprising the step of (1) subtracting time from the cumulated time when two or more (preferably three) of the measured length, width and height of the control point on the damaged structural component is out of tolerance with the standard length, width and height of the control point on the damaged structural component and/or (2) adding time to the cumulated time when the damaged structural component is fabricated from a form of high strength steel(s).

In the method, the measuring step may include the step of measuring the length, width and height dimension of the control point to an extent that is not noticeable to a naked eye such as to within 1 mm.

Additionally, a system for estimating time to repair a structurally damaged automobile is disclosed. The system may comprise a computer loaded with software for completing the steps of receiving length, width and height dimensions of a control point on the damaged structural component; based on a difference between the measured length, width and height and a standard length, width and height of the control point on the damaged structural component, assigning an estimated time to repair for each of the measured length, width and height; and cumulating the assigned times for the length, width and height to derive a cumulated estimated time to repair the control point; wherein the cumulated time is the estimated time to repair the damaged structural component.

The system may further comprise a central processing database in communication with a plurality of computers loaded with the software, wherein the computers download actual repair times and measurements of the control points to the central processing database.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an illustration of the auto repair estimation system;

FIG. 2 is an illustration of a measuring arm to measure a control point of a structural component of a vehicle;

FIG. 3 is an illustration of a computer screen of the auto repair estimation system shown in FIG. 1;

FIG. 4 is an exemplary table of structural components with an estimated time to repair associated with a range of displacement of a control point on the structural component; and

FIG. 5 is a flowchart of utilizing the auto repair estimation system.

### DETAILED DESCRIPTION

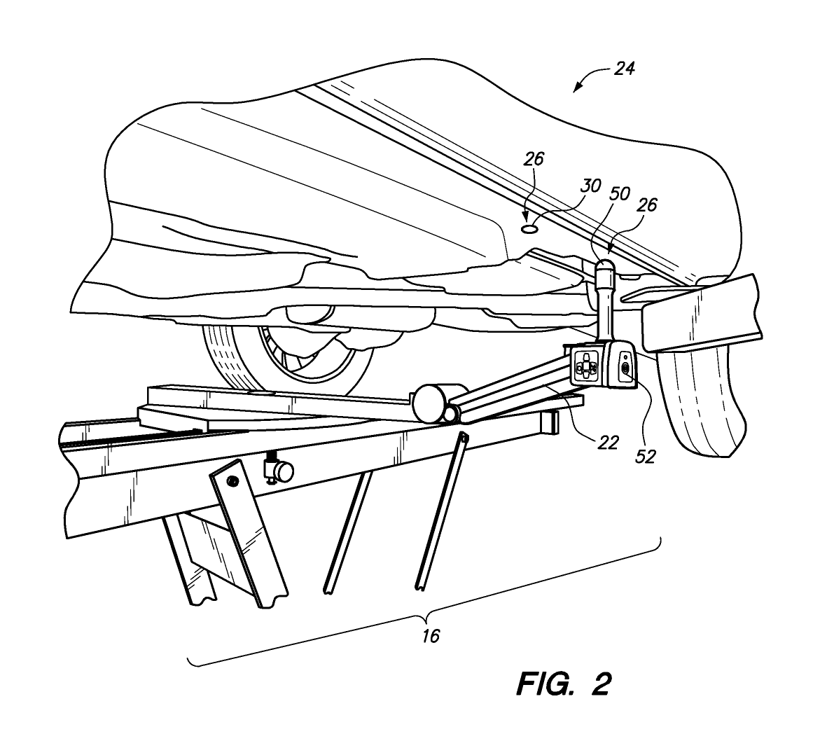

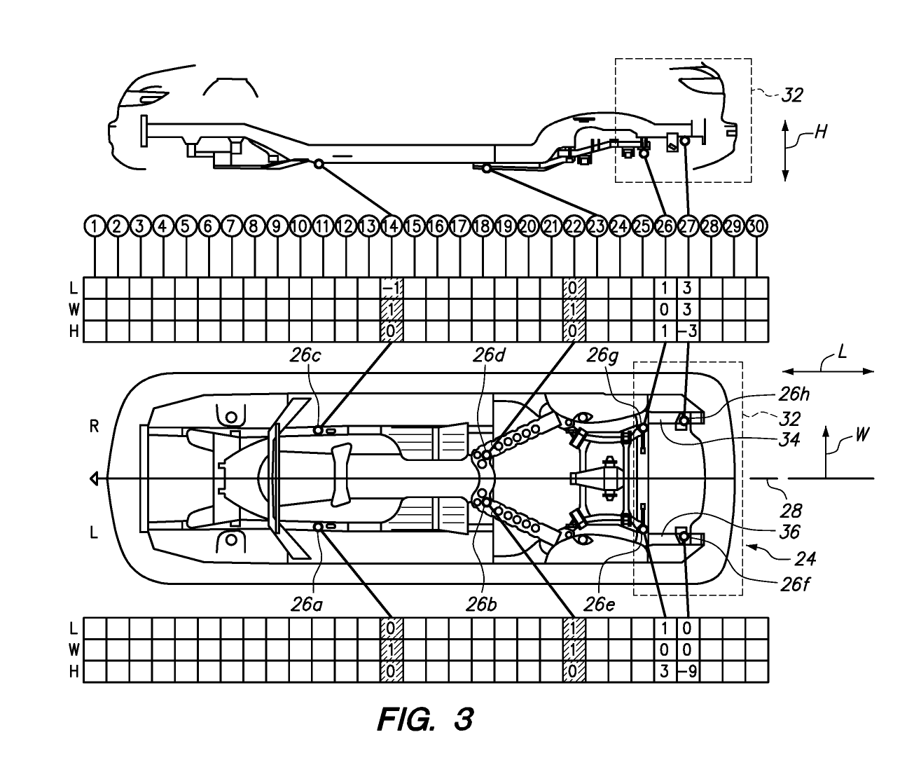

Referring now to the drawings, an auto repair estimation system 10 is shown. The system 10 may comprise a computer 12, a lift 14 and a measuring apparatus 16. The measuring apparatus 16 includes a stand 18 with a calibrated rail 20 and a measuring arm 22 that rides on the calibrated rail 20 and is capable of measuring spatial relationships between control points 26 (see FIGS. 2 and 3) on a vehicle 24. When the vehicle 24 is damaged, the control points 26 (see FIGS. 2 and 3) may be out of tolerance with respect to a manufacturer's stated acceptable tolerance range or a third party's acceptable tolerance range.

The arm 22 measures a length L position, width W position and height H position of the control point 26 with respect to reference or datum control points 26 on the vehicle 24 to determine the extent of the damage caused by an accident. The arm 22 is capable of measuring or detecting damage and the extent of damage that is not noticeable with the human eye. By way of example and not limitation, the length measurement L (see FIG. 3) is measured from a front to back direction of the vehicle 24. The width measurement W (see FIG. 3) is measured from a left to right or side to side direction. The height measurement H (see FIG. 3) is based on its vertical displacement. The measurements L, W and H may be measured in millimeters and/or fractions of an inch or to a degree not noticeable by the naked eye.

The computer 12 may be loaded with software that receives the L, W, H measurements of a plurality of control points 26 to determine an estimated time to repair damaged structural components of the damaged vehicle 24 to an acceptable condition (e.g., vehicle manufacturer specification, third party specification or industry accepted specification). By way of example and not limitation, the software may sum up the estimated time to repair the damaged structural part based on the extent that the length, width and height measurements of the plurality of control points 26 on the damaged structural component are out of tolerance. These displacement of the control points 26 may be unnoticeable with the human eye. Beneficially, the measuring apparatus 16 can catch these minute differences and assign a cost or time to this damage.

The software may also add to or subtract from the cumulated estimated time to repair based on one or more efficiencies and/or inefficiencies indicated by the L, W and H measurements of the plurality of control points 26. The efficiencies and inefficiencies may be based on the individual L, W and H measurements of a control point 26 and the amounts to which these measurements are out of tolerance. Also, the efficiencies and inefficiencies may be based on whether one, two or all three of the L, W and H measurements of a control point 26 are out of tolerance. By way of example and not limitation, when all three measurements (i.e., length, width and height of a control point) are out of tolerance, then the software may deduct from the cumulated estimated time to repair the structural component a certain time or percentage of time. Also, the efficiencies and inefficiencies may be based on the highest estimated time to repair between two or more control points 26 located on a single damaged structural component of the vehicle 24.

A plurality of automobile repair shops may utilize the auto repair estimation system 10 and transmit the actual time to repair the damaged vehicle 24 to a central database 27 and the out of tolerance L, W and H measurements of the repaired parts so as to refine the total estimated time to repair based on a greater statistical sample.

The auto repair estimation system disclosed herein enables an estimator to fine tune a repair estimate in relation to damages that may not be perceptible to the human eye. Additionally, the auto repair estimation system enables the estimator to access a database of prior actual repairs and the actual time to repair similar types of damage to the vehicle to justify its estimate.

Most, if not all, vehicles 24 sold within the United States have control points 26 which are also sometimes referred to as reference points. These measuring points may be located throughout the vehicle 24 and may be bolts, nuts, holes, seams, surfaces, etc. Technicians can also create control points 26 on the vehicle 24 and compare the control points 26 to the opposite side of the same vehicle 24, if not damaged. These control points 26 may be measured and its measurement used to estimate a time to bring the control point back into tolerance. The system disclosed herein uses the control points for estimation purposes.

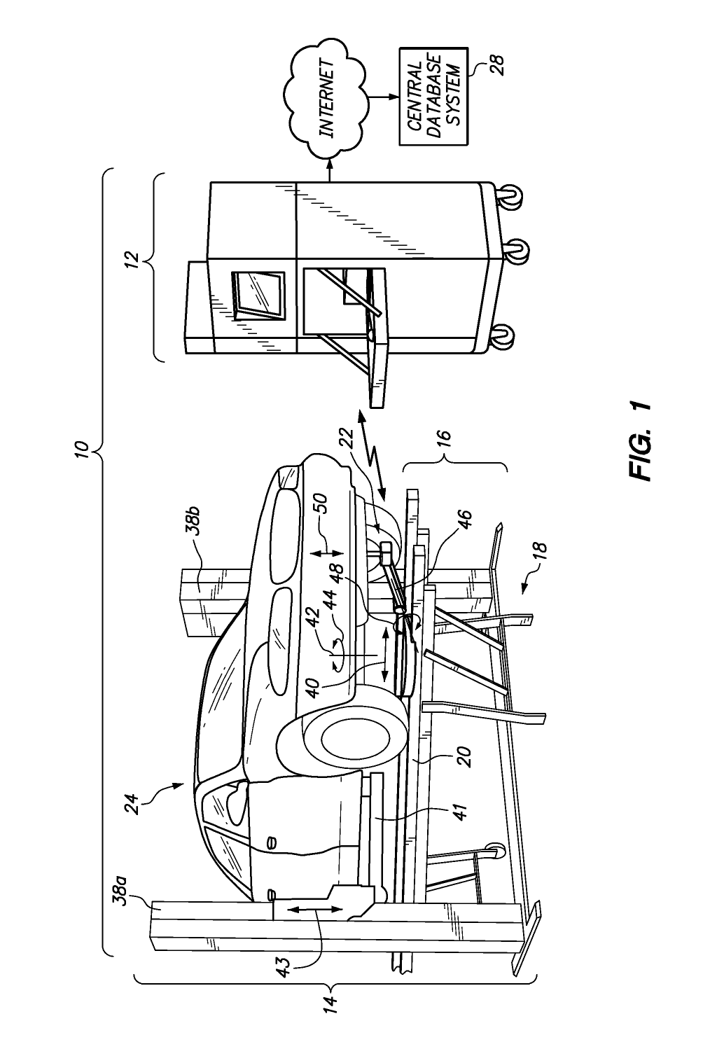

Referring now to FIG. 1, in order to more easily access the control points, the damaged vehicle 24 may be lifted off of the ground by way of lift 14. Other ways of accessing the control points are contemplated such as anchoring the vehicle 24 to a frame machine, a frame alignment bench or a four post lift. The lift 14 may have two or more posts 38a, b. The posts 38a, b may be located on sides of the damaged vehicle 24. Each of the posts 38a, b may have support arms 41 that extend inward and may be positioned under the vehicle 24 to raise the vehicle 24 above ground level. The support arms 41 can be adjusted vertically as shown by arrow 43. With the vehicle 24 lifted above ground level by the lift 14, control points 26 under the vehicle 24 may be more conveniently accessed for measurement. Control points 26 under the vehicle 24 are shown in FIGS. 2 and 3.

To measure the length L, width W, and height H measurements of one or more control points 26 of the vehicle, the measuring apparatus 16 may be set up underneath the damaged vehicle 24. In particular, a calibrated rail 20 may be disposed under the damaged vehicle 24 in a length wise direction. The rail 20 may be rolled under the damaged vehicle 24 and aligned generally to the length wise centerline 28 (see FIG. 3) of the damaged vehicle 24. The control arm 22 may then be mounted to the calibrated rail 20. The control arm 22 may slide lengthwise along the calibrated rail 20 in the direction of arrow 40. Additionally, the arm 22 may rotate about pivot axis 42 in the direction of arrow 44. Moreover, a measuring head 50 may be rotated about a generally horizontal axis 46 in the direction of arrow 48. The three (3) degrees of freedom provide the measuring head 50 the capability of touching any control point on the vehicle 24. If the measuring head 50 is too short or otherwise incapable of touching a surface or control point 26 of the vehicle 24, the measuring head 50 may be changed out with other longer, shorter, uniquely shaped measuring heads 50 in order to touch the desired surface or control point 26 of the vehicle 24. Once the calibrated rail 20 and arm 22 are set up under the vehicle 24, the arm 22 is then placed into communication (e.g., wireless or hardwired) with the computer 12.

To measure the L, W and H position of a control point, the measuring arm 22 is adjusted so that the measuring head 50 touches a control point 26. A button 52 (see FIG. 2) on the measuring arm 22 is depressed. The arm 22 may send a signal to the computer 12 regarding the length L, width W and height H measurement of that particular control point 26. The computer records the L, W and H measurement of the control point 26.

The damaged area 32 of the vehicle 24 may have one or more damaged structural components. For example, the rear end area 32 of the vehicle 24 shown in FIGS. 2 and 3 is damaged. This area 32 may have one or more structural components which needs repair. For the purposes of simplicity, let us assume that the vehicle 24 shown in the figures is damaged only at the rear lower left and right rails 36, 34. The rear lower left and right rails may have one or more control points 26e-h each.

Each of the control points 26e-h of the damaged structural components 34, 36 is measured with respect to its L, W and H measurement. For each of the 3 L, W and H measurement of each of the control points 26e-h, a time to repair is assigned. For example, if the L measurement of a control point is out of tolerance X_{L} inches or millimeters, a time of Y_{L} is assigned to bring the L dimension of the control point 26 for that particular part back into tolerance. If the W measurement of the control point 26 is out of tolerance X_{W} inches or millimeters, a time of Y_{W} is assigned to bring the W dimension of the control point 26 for that particular part back into tolerance. If the H measurement of the control point 26 is out of tolerance X_{H} inches or millimeters, a time of Y_{H} is assigned to bring the H dimension of the control point 26 for that particular part back into tolerance. The times to repair Y_{L}, Y_{W} and Y_{H} are cumulated which may be referred to as the cumulated estimated time to bring that control point of that particular damaged structural component back into tolerance.

If the structural component being measured has only one control point 26 associated therewith, then the cumulated time to bring the corresponding control point 26 back into tolerance is used as the total estimated time to repair that particular structural component. However, if the damaged structural component has more than one control point 26 associated therewith, then the L, W and H measurement for the other control points 26 on that damaged structural component may be taken. A time to repair the control points 26 on the structural part is determined independent from the other control points 26. The control point with the highest estimated time to repair after deductions and additions are taken is used as the total estimated time to repair such structural component.

For each of the L, W and H measurements of a control point 26, the same may be out of tolerance one or more millimeters or fractions of an inch. The estimated time to bring a particular control point 26 back within tolerance may increase as the degree to which the control point 26 is out of tolerance increases. By way of example and not limitation, an estimated time to repair of 0.5 hours may be associated for a L, W or H measurement that is out of tolerance 1 mm. The estimated time to repair may be 1 hour for a L, W or H measurement that is out of tolerance 2 mm. It is also contemplated that the estimated time to repair may be the same for a range of distances. For example, the estimated time to repair may be 0.5 hours for a L, W or H measurement that is out of tolerance 3-4 mm, 1 hour for 5-6 mm, etc. After a certain point, the estimated time to repair may level off. For example, if the L, W or H measurement is out of tolerance more than 15 mm, then the estimated time to repair may be equal to 2 hours.

The estimated time to repair may be different for each of the L, W and H measurements. By way of example and not limitation, a 2 mm out of tolerance L measurement may be associated with a 0.5 hour estimated time to repair, whereas a 2 mm out of tolerance W measurement for the same control point 26 may be associated with a 0.75 hour estimated time to repair.

After the total estimated time to repair is determined, deductions may be made to the total estimated time to repair to bring a control point back into tolerance. By way of example and not limitation, when three of the L, W and H measurements of a control point 26 are out of tolerance, then a percentage deduction or a standard set time may be subtracted from the cumulated estimated time to bring the control point back into tolerance. It is also contemplated that the deduction may be taken when two of the L, W and H measurements of the control point 26 are out of tolerance. However, for the purposes of simplicity, the examples and discussion provided herein are given for the instance where the deduction is taken when all three of the L, W and H measurements of a control point 26 are out of tolerance. The deduction may be a twenty (20) percent deduction from the cumulated estimated time to repair. The 20% deduction number is provided merely for purpose of providing an example and not to limit the percentage to a particular number. Other percentages are also contemplated.

By way of example and limitation, the L, W and H measurement for a particular control point 26 may all be out of tolerance. The estimated time to repair the L dimension may be 1 hour. The estimated time to repair the W dimension may be 1 hour. The estimated time to repair the H dimension may be 1 hour. The cumulated estimated time to repair the control point is three (3) hours. Since all three dimensions L, W and H are out of tolerance, a 20% deduction in the cumulated time to repair may be taken. Hence, the new total estimated time to repair may be 2.4 hours (i.e., 3 hours less 20% of 3 hours).

Certain control points 26 may receive no deduction even though all three L, W and H measurements of the control point is out of tolerance. By way of example, when the damaged structural component is on the side aperture (e.g., side doors) or the rear aperture (hatch back, trunk, etc.).

When there are multiple control points 26 on the damaged structural component, then the highest cumulated estimated time to repair after deductions and additions of the various control points is used as the total estimated time to repair the damaged structural component. By way of example and not limitation, if the damaged structural component had first and second control points 26. The measurements for L, H and W of the first control point 26 are all out of tolerance. The cumulated time to repair the L, H and W dimensions is 3 hours. Since all three measurements L, W and H are out of tolerance, the total estimated time to repair the first control point 26 is assigned a time of 2.4 hours. If the second control point 26 of the damaged structural component had one or two of the L, W and H measurements out of tolerance, then the estimated time to repair each out of tolerance measurement is cumulated. If the cumulated estimated time to repair the second control point 26 is 2.6 hours, then the total estimated time to repair the damaged structural component may be assigned 2.6 hours. The 2.4 hour estimate is ignored. If the cumulated estimated time to repair the second control point 26 is 2.2 hours, then the total estimated time to repair the damaged structural component may be 2.4 hours. The 2.2 hour estimate is ignored.

Other additions and deductions to the cumulated estimated time to repair may be made to arrive at the total estimated time to repair a control point. The normal estimated time to repair the L, W and H measurements may be provided with the assumption that the material of the damaged structural component is made from regular steel. However, if the damaged structural component is fabricated from high strength steel, then the estimated total time to repair the damaged structural component may be increased by a percentage or a fixed time. The addition or extra time allowance for the high strength steel (i.e., type of material) may be made after cumulating the estimated time to repair the control point 26 for the L, W and H measurements. The addition or extra time allowance for the high strength steel may be made after taking deductions when all three L, W and H conditions of the control point 26 are out of tolerance.

Conversely, it is also contemplated that deductions may be made for the type of material of the damaged structural component. It is contemplated that the estimated time to repair the L, W and H measurements may be provided with the assumption that the material of the damaged structural component is made from high strength steel. Deductions are taken when the material of the damaged structural component is regular steel.

Control points 26 are located on various parts of the vehicle 24 and may be spatially measured with respect to each other to measure the extent of the damage to the conventional frame or unibody construction of the damaged vehicle 24. FIG. 3 is an illustration of a computer screen showing a bottom view and side view of the vehicle 24 with the associated control points 26 shown as circles. Each of the control points 26 have an associated tolerance with respect to length L, width W and height H. FIG. 2 illustrates the measuring arm 22 of the measuring apparatus 16 taking a length, width and height measurement of a control point 26. The measuring arm 22 may have a measuring tip or head 50 that may be inserted into a hole 30 on the frame or unibody of the vehicle 24 or other feature of the vehicle 24 that defines the control point 26. The measuring head 50 may also be touched against a surface or other feature of the vehicle for comparison to the other side of the vehicle.

To start measuring the damaged area 32 (see FIG. 3), a reference “torque box” must first be measured or defined. The “torque box” provides a reference frame to which the control points 26 in the damaged area 32 is measured. The “torque box” establishes length, width and height from which the other control points are checked against to determine degree of damage. In other words, it establishes datum that determines heights, centerline for width and a reference location from which lengths are determined for all other control points. In the event that the “torque box” area (i.e., central area) is damaged, any other three or more points can be used on the vehicle such as the undamaged front or rear end portions of the vehicle. The measuring arm 22 may measure three or more control points in the “torque box” area. In FIG. 3, four control points 26a-d were measured in the “torque box” area. The control points 26a, b are on the left side of the vehicle 24. The control points 26c, d are on the right side of the vehicle 24. Preferably, but not necessarily, the control points 26a, b are symmetrical with respect to the control points 26c, d. In other words, the control points 26a, b are the same control points as the control points 26c, d except that they are on the left and right sides of the vehicle 24. Two control points 26a, b and 26c, d on each side of the damaged vehicle 24 may be measured. These control points 26a-d make up the reference “torque box” or datum and must be within tolerance since the “torque box” measurements provide the reference frame to which all of the other control points 26 in or around the damaged area 32 of the damaged vehicle 24 will be measured. As can be seen from FIG. 3, the measuring apparatus 16 and the computer 12 are capable of detecting the length L, width W and height H measurements of the control points 26 to within 1 mm in each of the length L, width W and height H directions.

Once the “torque box” measurement is made, the control points 26 of the damaged or affected area of the damaged vehicle 24 may be measured by the measuring arm 22. For purposes of simplicity, the acceptable tolerance range will be assumed to be 2 mm in each of the height H, width W and length L directions for each of the control points 26. However, each manufacturer may specify different tolerance ranges for their particular vehicle 24. Also, each manufacturer may specify different tolerance ranges for each of the control points 26 on the vehicle 24. The computer 12 calculates the spatial relationship between these control points 26a-d so as to define the reference “torque box” and determines the spatial mismatch between these points with respect to its length, width and height. The control point 26d is spot on with respect to its height and length. However, with respect to width, it is 1 mm off. The same is true for the other control points 26a-c in that at least one of the L, W and/or H measurements of the control points 26a-c is not spot on. Nonetheless, the L, W and H measurements of these four control points 26a-d are all within the assumed 2 mm tolerance to each other and may be used to define the reference frame or datum (i.e., “torque box”) to which the control points 26 in the damaged area 32 of the vehicle 24 is measured.

In the example shown in FIG. 3, the rear end of the vehicle 24 is damaged. Accordingly, a technician may measure one or more control points 26 in the rear end area 32 of the damaged vehicle 24 with the measuring apparatus 16. In this example, the technician measured the control points 26e-h within the damaged area 32 showing damage to the rear lower left and right rails 36, 34. Control point 26e is within tolerance with respect to the length L and the width W measurement, but out of tolerance with respect to the height H measurement. This information is sent to the computer 12. The computer 12 may have a database of estimated time to repair the height H location of the control point 26e on the rear lower left rail 34 based on the H measurement of the control point 26e of the rear lower left rail 36. Based on the extent to which the height location of the control point 26e is displaced or out of tolerance, a corresponding estimated time to repair the height dimension of control point 26e of the rear lower left rail 36 is associated with such measurement. No estimated time to repair is associated to the L and W since these measurements show that the location of the control point 26e with respect to L and W is within tolerance.

Now, with respect to control point 26g, the same 26g is within tolerance. As such, no time is allotted to repair such control point 26g of the rear lower right rail 34. With respect to control point 26f, the L and W locations of the control point 26f are spot on or within tolerance. However, the H location of control point 26f is off 9 mm or 7 mm out of tolerance. The estimated time to repair control point 26f is attributable only to the H measurement of the control point 26f. In relation to control point 26h, each of the L, W and H measurements are out of tolerance. An estimated time to repair is associated with each of the L, W and H measurement and cumulated to arrive at a cumulated estimated time to repair control point 26h. However, since all three L, W and H measurements are out of tolerance, a deduction is made from the cumulated estimated time to repair the control point 26. For each control point 26, an estimated time to repair is associated with each of the length, width and height measurements when such measurement is out of tolerance. When two of the three length L, width W and height H measurements are out of tolerance, then the estimated time to repair is cumulated. However, when all three length L, width W and height H measurements of a control point 26 such as that in relation to control point 26h are out of tolerance, then the estimated time to repair associated with each of the length L, width W and height H is cumulated then a deduction (e.g., percentage or fixed time) may be made due to efficiencies in the repair process when all three L, W and H dimensions must be repaired. If the control points 26e-h are on different structural components, then the estimated time to repair the rear end of the vehicle is the summation of estimated times calculated for each of the control points 26e-h.

If control point 26g is also on the rear lower right rail 34, then the higher of the two estimated time to repair control points 26g and 26h is used as the estimated time to repair. Also, if the control point 26e is on the rear lower left rail 36, then the higher of the two estimated time to repair control points 26e and 26f is used as the estimated time to repair. In this case, the higher estimated time associated with one of the control points 26g and 26h is added to the higher estimated time associated with one of the control points 26e and 26f to arrive at the estimated time to repair the rear end of the vehicle.

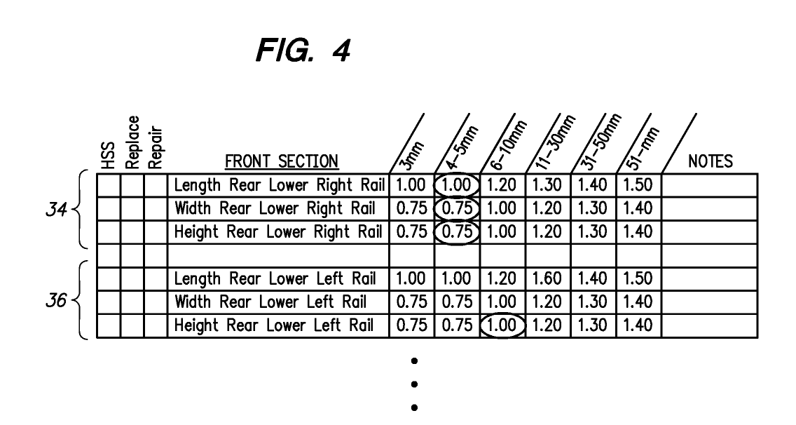

Referring now to FIG. 4, two structural components are identified, namely, the rear lower right rail 34 and the rear lower left rail 36. The table shown in FIG. 4 is a partial list of structural components of the vehicle. Other structural components are not listed in order to simplify the table shown in FIG. 4. Moreover, the list of structural components may reflect the type of body of the vehicle. For example, the list of structural components may represent structural components for a conventional frame, unibody frame or a hybrid conventional frame and unibody construction. Other structural components may be the rear right section, rear left section, front lower right rail, front upper right rail, front lower left rail, front upper left rail, etc. These other structural components are listed for the purpose of illustration.

For each of the structural components, three measurements L, W and H may be taken. The measurements of L, W and H are taken at the control point 26 for the structural component if and when damaged. If there are more than one control point associated with the structural component then the additional control points 26 may be added to the table.

One or more ranges of displacement may be associated for each of the L, W and H measurements. By way of example, the ranges may be 3 mm, 4-5 mm, 6-10 mm, 11-30 mm, 31-50 mm, 51 mm or more. The span of the ranges may increase as the displacement increases. For example, at the lower end of the spectrum of the ranges, the span of the ranges may be 1 mm (i.e., 5 mm−4 mm). At the higher end of the spectrum of the ranges, the span of the ranges may be 19 mm (i.e., 50 mm−31 mm). Generally, as the displacement for the L, W and H measurement of the control point 26 increases, the estimated time to repair the L, W and H dimension of the control point 26 increases. The increase may be linear but may also follow other curves such as stair step (e.g., x time for displacements below y mm but z time for displacements above y mm), parabolic, inverse parabolic. It is also contemplated that the ranges throughout the spectrum may be 1 mm or the smallest increment measureable by the measuring apparatus 16.

The measuring system may track and calculate the measurements for the L, W and H regarding each of the control points 26 internally within its software, memory and processor. The screen of the computer 12 provides an output such as the table shown in FIG. 4 and the graphical display shown in FIG. 3 to provide a graphical user interface which is easily readable by a person.

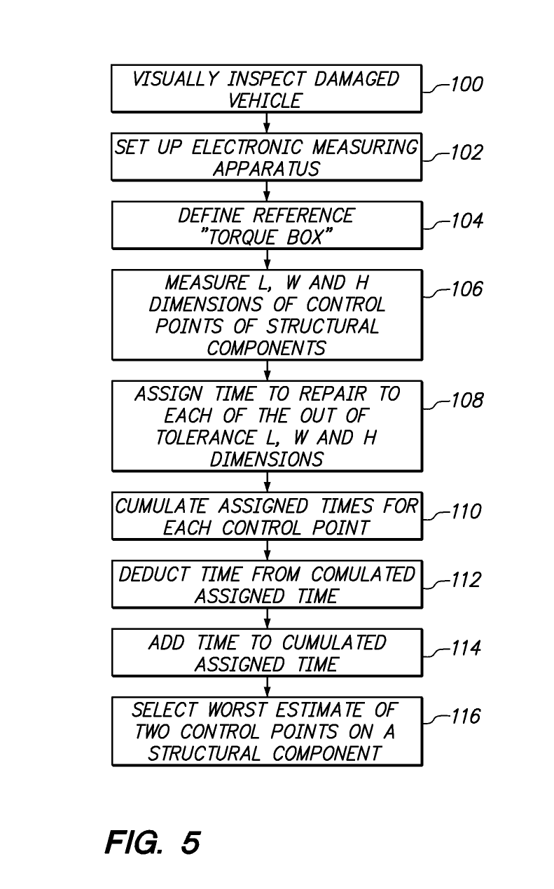

Referring now to FIG. 5, a flow chart for estimating cost to repair a damaged vehicle 24 is shown. When an auto body repair shop receives a damaged vehicle to be repaired, the auto body repair shop visually inspects 100 the damaged vehicle 24. They look at the point of impact on the damaged vehicle and visualize how the impact may have affected other areas of the vehicle. These other areas may not appear to be damaged visually but may be out of tolerance when measured with the measuring apparatus 16. The damaged vehicle 24 may be placed on a lift 24 to raise the damaged vehicle 24 above ground level to make control points 26 under the vehicle 24 more easily accessible for measurements. The electronic measuring apparatus 16 is set up 102 to take measurements of various control points 26 on the vehicle to determine the extent of damage to the vehicle. To start measuring the damaged area of the vehicle 24, the measuring apparatus in conjunction with a computer must first define a reference “torque box” 104. This is the reference frame or datum to which the control points 26 within the damaged area is measured.

After the reference “torque box” is defined 104, the control points 26 within the damaged area which were identified during the visual inspection stage are measured 106. Each control point 26 is measured with respect to its length L, width W and height H position with respect to the reference “torque box.” When the L, W and H position is out of tolerance, an estimated time to repair the L, W or H position is assigned 108. For example, if two or three of the L, W and H positions are out of tolerance, then those two or three positions are assigned 108 an estimated time to repair. The assigned times are cumulated 110 to arrive at a cumulated estimated time to repair a particular control point 26.

Based on certain efficiencies in repairing a control point or bringing the control point back into tolerance, a deduction 112 may be made to the cumulated estimated time to repair. By way of example and not limitation, if three of the L, W and H positions are out of tolerance, then a percentage deduction or a fixed time deduction may be made to the cumulated estimated to repair the control point.

Also, based on certain inefficiencies in repairing the control point or bringing the control point back into tolerance, an addition 114 may be made to the cumulated estimated time to repair. By way of example and not limitation, if the control point 26 being measured is associated with a part made from high strength steel, then a percentage or fixed time may be added 114 to the cumulated estimated time to repair the control point 26 due to the difficulty in working with high strength steel.

If there are two control points on a structural component, then the above process for estimating the time to repair each of the control points is performed. The higher of the two estimated times to repair regarding the two control points on that structural component is selected 116 for the structural component as the estimated time to repair. The lower estimate is not used. If there is only one control point on the structural component, then the estimated time to repair that one control point is used as the estimated time to repair the structural component.

The deductions and additions to the total estimated time to repair discussed herein are only exemplary and not exhaustive. Other adjustments to the total estimated time to repair are also contemplated. For example, additions and deductions may be taken based on a direction of the displacement of the control point. If the displacement of the control point is inward, then a greater time to repair may be assigned compared to the situation where the control point is displaced outward, and vice versa. If the displacement of the control point is upward, then a greater time to repair may be assigned compared to the situation where the control point is displaced downward, and vice versa.

Other factors may increase or decrease the total estimated time to repair. By way of example and not limitation, time may be added for (1) measure during repair, (2) set up for unibody standard, (3) set up for unibody special, (4) set up for non drivable vehicles, (5) set up for disabled vehicles that do not roll, (6) set up for universal fixture kit right front, (7) set up for universal fixture kit left front, (8) set up for universal fixture kit right rear, (9) set up for universal fixture kit left rear, (10) dedicated fixture kit complete and (11) dedicated fixture kit modified.

The estimation method and system disclosed herein provides a method for estimating the time to repair a structural component of a vehicle that has been damaged in an accident. The structural component may be associated with a conventional frame or a unibody frame or even a vehicle that has a hybrid construction in both a conventional frame and unibody construction. The time to repair the damaged structural component or components may be converted into a cost by multiplying the total estimated time to repair by a labor rate. The total estimated time to repair derived from the method and system disclosed herein is associated with only bringing the damaged structural component back to an acceptable condition such as a vehicle manufacturer specification, third party specification or industry accepted specification. Aesthetic parts are not included in the estimation process disclosed herein. Aesthetic parts are those parts which are primarily aesthetic panels, features, etc. of the vehicle. Additionally, the system does not address repairing and replacing panels.

The measuring system 16 discussed herein utilizes a measuring head 50 or a probe that physically contacts a control point on the vehicle. However, it is also contemplated that other types of measuring systems may be utilized in lieu of the measuring system 16 discussed above. By way of example and not limitation, a velocity measuring system may be used. Instead of using a robotic measuring arm such as the ones discussed above, the velocity system utilizes targets hung from control points on the vehicle that a laser reads to determine length, width and height and compares such information to a database of established values for each car make and model. Another type of measuring system is a sonar based system. The sonar based measuring system utilizes sonar to measure the vehicle. Sensors are hung from control points and a sonar beam calculates the length, width and height of the control points and makes the comparison against a database. These systems provide more accurate information or measuring capabilities than the naked eye. Accordingly, the auto repair estimation system discussed herein is not dependent upon the type of measuring system being used to measure the control points on the vehicle.

The above description is given by way of example, and not limitation. Given the above disclosure, one skilled in the art could devise variations that are within the scope and spirit of the invention disclosed herein, including various ways of measuring the control points 26. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method for estimating time to repair a structurally damaged automobile, the method comprising the steps of:
identifying a damaged structural component of the structurally damaged automobile;
electronically measuring length, width and height dimensions of a control point on the damaged structural component;
based on a difference between the measured length, width and height and a standard length, width and height of the control point on the damaged structural component, assigning an estimated time to repair for each of the measured length, width and height; and
cumulating the assigned times for the length, width and height to derive a cumulated estimated time to repair the control point;
wherein the cumulated time is the estimated time to repair the damaged structural component.

2. The method of claim 1 wherein the damaged structural component has two or more control points, and at least two of the control points are measured and a cumulated time to repair each of the control points is derived, wherein the higher of the two cumulated times to repair is used as the estimated time to repair the damaged structural component.

3. The method of claim 1 further comprising the steps of:
identifying additional damaged structural components of the structurally damaged automobile;
for each of the identified damaged structural components, measuring length, width and height dimensions of one or more control points on the damaged structural component;
for each of the control points, assigning an estimated time to repair each of the measured length, width and height; and
cumulating the assigned times for the length, width and height of each control point.

4. The method of claim 1 further comprising the steps of:
assigning a first estimated time to repair the length, width and height of the control point for a first difference;
assigning a second estimated time to repair the length, width and height of the control point for a second difference wherein the second estimated time to repair is greater than the first estimated time to repair when the second difference is greater than the first difference.

5. The method of claim 1 further comprising the step of:
subtracting time from the cumulated time when two or more of the measured length, width and height of the control point on the damaged structural component is out of tolerance with the standard length, width and height of the control point on the damaged structural component.

6. The method of claim 1 further comprising the step of:
adding time to the cumulated time when the damaged structural component is fabricated from high strength steel.

7. The method of claim 1 wherein the measuring step includes the step of measuring the length, width and height dimension of the control point to an extent that is not noticeable to a naked eye.

8. The method of claim 7 wherein the length, width and height dimension of the control point is measured to within 1 mm.

9. A system for estimating time to repair a structurally damaged automobile, the system comprising:
a computer loaded with software for completing the steps of:
receiving length, width and height dimensions of a control point on the damaged structural component;
based on a difference between the measured length, width and height and a standard length, width and height of the control point on the damaged structural component, assigning an estimated time to repair for each of the measured length, width and height; and
cumulating the assigned times for the length, width and height to derive a cumulated estimated time to repair the control point;
wherein the cumulated time is the estimated time to repair the damaged structural component.

10. The system of claim 9 further comprising a central processing database in communication with a plurality of computers loaded with the software, wherein the computers download actual repair times and measurements of the control points to the central processing database.
